(19) United States
(12) Patent Application Publication
(10) Pub. No.: US 2025/0167543 A1
(43) Pub. Date: May 22, 2025

(54) INTEGRATED CIRCUIT CAPABLE OF WITHSTANDING ELECTRICAL OVER STRESS

(71) Applicant: VIA LABS, INC., New Taipei City (TW)

(72) Inventors: Jung-Chang Liu, New Taipei City (TW); Chia Wei Chang, New Taipei City (TW)

(73) Assignee: VIA LABS, INC., New Taipei City (TW)

(21) Appl. No.: 18/671,921

(22) Filed: May 22, 2024

(30) Foreign Application Priority Data
Nov. 21, 2023 (TW) 112144985

(51) Int. Cl. H02H 9/04

(52) U.S. Cl. CPC H02H 9/046

(57) ABSTRACT

An integrated circuit that may withstand electrical over stress (EOS) is provided. The integrated circuit includes a core circuit, a connecting pad, a high-pass filter (HPF), an electrostatic discharge (ESD) protection circuit and an ESD enhanced-protection circuit. A first terminal of the HPF is coupled to the connecting pad. The ESD protection circuit is coupled to the connecting pad and the first terminal of the HPF. A first terminal of the ESD enhanced-protection circuit is coupled to a second terminal of the HPF. A second terminal of the ESD enhanced-protection circuit is coupled to a signal terminal of the core circuit.

### CROSS-REFERENCE TO RELATED APPLICATION

This application claims the priority benefit of Taiwan application serial no. 112144985, filed on Nov. 21, 2023. The entirety of the above-mentioned patent application is hereby incorporated by reference herein and made a part of this specification.

### BACKGROUND

### Technical Field

The invention relates to an electronic circuit, and more particularly, to an integrated circuit that may withstand electrical over stress.

### Description of Related Art

Static electricity is everywhere. When a component encounters a voltage or current that exceeds its load capacity, the component may easily burn out. This is an electrical over stress (EOS) problem. Generally, a soldering pad (or connecting pad) of an integrated circuit has an electrostatic discharge (ESD) protection circuit. When an ESD event occurs on the soldering pad, the ESD protection circuit located on the soldering pad may opportunely guide an ESD current to a reference voltage line to prevent an ESD voltage or current from damaging a core circuit.

Generally, the ESD protection circuit located on the soldering pad may effectively prevent a human-body model (HBM) or machine model (MM) level ESD power from damaging the core circuit. An MM level ESD voltage (peak) is approximately 100 to 200 volts. An HBM level ESD voltage (peak) is about 500 to 2000 volts, and a rise time is about 25 ns. However, when a higher voltage and faster EOS event occurs on the soldering pad, such as an IEC-61000-4-2 model level ESD power occurs, the ESD protection circuit located on the soldering pad may not have time to direct the ESD current to the reference voltage line, resulting in a fact that the EOS voltage or current damages the core circuit. The IEC-61000-4-2 model level ESD voltage (peak) is approximately 2000 to 15000 volts with a rise time of less than 1 ns. How to withstand higher voltage and faster EOS is one of many technical issues in the field of integrated circuit technology.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention provides an integrated circuit, which provides an electrostatic discharge (ESD) protection function and may withstand electrical over stress (EOS).

In an embodiment of the invention, the above-mentioned integrated circuit includes a core circuit, a connecting pad, a high-pass filter (HPF), an electrostatic discharge (ESD) protection circuit and an ESD enhanced-protection circuit. A first terminal of the HPF is coupled to the connecting pad. The ESD protection circuit is coupled to the connecting pad and the first terminal of the HPF. A first terminal of the ESD enhanced-protection circuit is coupled to a second terminal of the HPF. A second terminal of the ESD enhanced-protection circuit is coupled to a signal terminal of the core circuit.

Based on the above, the ESD protection circuit described in the embodiment of the invention may provide an ESD protection function. For example, in some application scenarios, the ESD protection circuit may effectively prevent human-body model (HBM) or machine model (MM) level ESD power from damaging the core circuit. When a higher voltage and faster EOS event occurs on the connecting pad, such as an IEC-61000-4-2 model level ESD power occurs, the ESD protection circuit may not have time to direct all of EOS power to a reference voltage line, causing some of the EOS power to possibly pass through the HPF. At this time, the ESD enhanced-protection circuit may effectively prevent the EOS power that has passed through the HPF from damaging the core circuit.

In order for the aforementioned features and advantages of the invention to be more comprehensible, several embodiments accompanied with drawings are described in detail as follows.

### BRIEF DESCRIPTION OF THE DRAWINGS

FIG. 1 is a schematic circuit block diagram of an integrated circuit according to an embodiment of the invention.

FIG. 2 is a schematic circuit diagram of an ESD protection circuit, a high-pass filter and an ESD enhanced-protection circuit according to an embodiment of the invention.

FIG. 3 is a schematic circuit diagram of an ESD enhanced-protection circuit according to another embodiment of the invention.

FIG. 4 is a schematic circuit diagram of an ESD enhanced-protection circuit according to still another embodiment of the invention.

FIG. 5 is a schematic circuit diagram of an ESD enhanced-protection circuit according to still another embodiment of the invention.

FIG. 6 is a schematic circuit diagram of an ESD enhanced-protection circuit according to still another embodiment of the invention.

FIG. 7 is a schematic circuit block diagram of an integrated circuit according to another embodiment of the invention.

FIG. 8 is a schematic circuit block diagram of an integrated circuit according to another embodiment of the invention.

### DESCRIPTION OF THE EMBODIMENTS

A term “couple” used in the full text of the disclosure (including the claims) refers to any direct and indirect connections. For example, if a first device is described to be coupled to a second device, it is interpreted as that the first device is directly coupled to the second device, or the first device is indirectly coupled to the second device through other devices or connection means. The terms “first” and “second” mentioned in the full text of the specification (including the claims) are used to name elements or to distinguish different embodiments or scopes, and are not used to limit an upper limit or a lower limit of the number of elements, nor are they used to limit an order of the elements. Moreover, wherever possible, elements/members/steps using the same referential numbers in the drawings and description refer to the same or like parts. Elements/members/steps using the same referential numbers or using the same terms in different embodiments may cross-refer related descriptions.

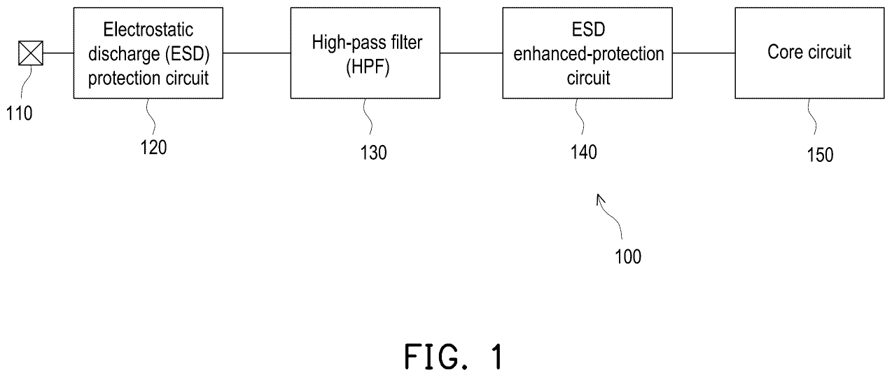

FIG. 1 is a schematic circuit block diagram of an integrated circuit 100 according to an embodiment of the invention. The integrated circuit 100 shown in FIG. 1 includes a connecting pad 110, an electrostatic discharge (ESD) protection circuit 120, a high-pass filter (HPF) 130, an ESD enhanced-protection circuit 140 and a core circuit 150. Based on the actual design, in different embodiments, the core circuit 150 may include one or a plurality of different functional circuits. For example, in some embodiments, the core circuit 150 may include an equalizer, a loss of signal (LOS) detection circuit, an amplifier and/or other functional circuits.

Based on the actual design, in different embodiments, the connecting pad 110 (such as a soldering pad) may be a signal input connecting pad or other connecting pads. A first terminal of the high-pass filter 130 is coupled to the connecting pad 110. Based on an actual design, the high-pass filter 130 may include any type of filter circuit, such as a well-known high-pass filter or other filter circuits.

The ESD protection circuit 120 is coupled to the connection pad 110 and the first terminal of the high-pass filter 130. The ESD protection circuit 120 may provide an ESD protection function. The embodiment does not limit implementation details of the ESD protection circuit 120. According to the actual design, in some embodiments, the ESD protection circuit 120 may include a well-known ESD protection circuit or other ESD protection circuits. When a human-body model (HBM) or machine model (MM) level ESD event occurs on the connecting pad 110, the ESD protection circuit coupled to the connecting pad 110 may effectively prevent ESD energy from damaging the core circuit 150.

When a higher voltage and faster electrical over stress (EOS) event occurs on the connecting pad 110, such as an IEC-61000-4-2 model level ESD power occurs, the ESD protection circuit 120 may probably not have time to direct all EOS power to a reference voltage line (not shown in FIG. 1). At this time, the EOS power of the connecting pad 110 may pass through the high-pass filter 130.

A first terminal of the ESD enhanced-protection circuit 140 is coupled to a second terminal of the high-pass filter 130. A second terminal of the ESD enhanced-protection circuit 140 is coupled to a signal terminal of the core circuit. When the EOS power of the connecting pad 110 passes through the high-pass filter 130, the ESD enhanced-protection circuit 140 may effectively prevent the EOS power that has passed through the high-pass filter 130 from damaging the core circuit 150. For example, in some embodiments, the ESD enhanced-protection circuit 140 may guide an EOS current to the reference voltage line (not shown in FIG. 1). In some embodiments, the ESD enhanced-protection circuit 140 may effectively reduce the EOS current flowing to the core circuit 150.

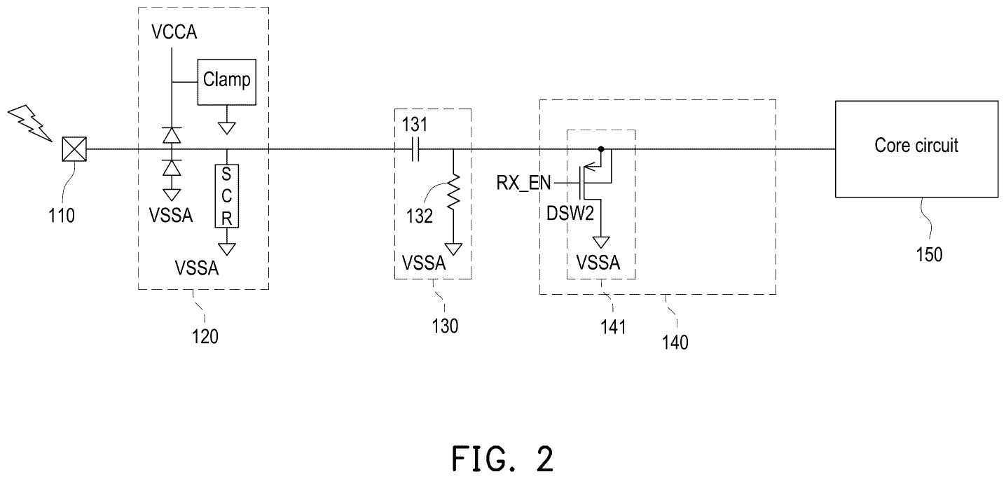

FIG. 2 is a schematic circuit diagram of the ESD protection circuit 120, the high-pass filter 130 and the ESD enhanced-protection circuit 140 according to an embodiment of the invention. For the ESD protection circuit 120, the high-pass filter 130 and the ESD enhanced-protection circuit 140 shown in FIG. 2, reference may be made to the related descriptions of the ESD protection circuit 120, the high-pass filter 130 and the ESD enhanced-protection circuit 140 shown in FIG. 1. The ESD protection circuit 120, the high-pass filter 130 and the ESD enhanced-protection circuit 140 shown in FIG. 2 may be used as one of many implementations of the ESD protection circuit 120, the high-pass filter 130 and the ESD enhanced-protection circuit 140 shown in FIG. 1.

The ESD protection circuit 120 shown in FIG. 2 shows a well-known ESD protection circuit, which includes diodes, a clamp circuit and a silicon controlled rectifier (SCR). When a positive ESD pulse occurs in the connecting pad 110, the diodes of the ESD protection circuit 120 may opportunely guide an ESD current from the connecting pad 110 to a system voltage line VCCA, and/or the silicon controlled rectifier of the ESD protection circuit 120 may opportunely guide the ESD current from the connecting pad 110 to a reference voltage line VSSA. When a negative ESD pulse occurs at the connecting pad 110, the diodes of the ESD protection circuit 120 may opportunely guide the ESD current from the reference voltage line VSSA to the connecting pad 110. Therefore, the ESD protection circuit 120 may prevent ESD voltage or current from damaging the core circuit 150. It should be noted that a specific implementation of the ESD protection circuit 120 should not be limited to the circuit diagram shown in FIG. 2. According to the actual design, the ESD protection circuit 120 may include other ESD circuits.

In the embodiment shown in FIG. 2, the high-pass filter 130 includes a capacitor 131 and a resistor 132. A first terminal of the capacitor 131 is coupled to the first terminal of the high-pass filter 130, i.e., coupled to the connecting pad 110. A second terminal of the capacitor 131 is coupled to the second terminal of the high-pass filter 130, i.e., coupled to the first terminal of the ESD enhanced-protection circuit 140. A capacitance of the capacitor 131 may be determined according to an actual design. For example, in some embodiments, the capacitance of the capacitor 131 may be within a range from 1 pF to 10 pF. A first terminal of the resistor 132 is coupled to the second terminal of the capacitor 131. A second terminal of the resistor 132 is coupled to the reference voltage line VSSA. A resistance of the resistor 132 may be determined according to the actual design. For example, in some embodiments, the resistance of the resistor 132 may be within a range from 100 KΩ to 500 KΩ. It should be noted that the specific implementation of the high-pass filter 130 should not be limited to the circuit diagram shown in FIG. 2. According to the actual design, the high-pass filter 130 may include other filter circuits.

The specific implementation of the ESD enhanced-protection circuit 140 should not be limited to the circuit diagram shown in FIG. 2. According to the actual design, the ESD enhanced-protection circuit 140 may have other ESD circuits. In the embodiment shown in FIG. 2, the ESD enhanced-protection circuit 140 includes a receiving end high-impedance ESD circuit 141. The receiving end high-impedance ESD circuit 141 includes a discharge switch DSW2. A first terminal of the discharge switch DSW2 is coupled to the second terminal of the high-pass filter 130 and the signal terminal of the core circuit 150. A second terminal of the discharge switch DSW2 is coupled to the reference voltage line VSSA. A control terminal of the discharge switch DSW2 is controlled by an enable signal RX_EN of the core circuit 150.

After the integrated circuit 100 is powered on, when the enable signal RX_EN indicates enabling (i.e., a transmission channel from the connecting pad 110 to the core circuit 150 is enabled), the discharge switch DSW2 is turn off. For example, when the enable signal RX_EN is at a high logic level, the discharge switch DSW2 is turned off. Since the discharge switch DSW2 is turned off, the ESD enhanced-protection circuit 140 will not affect a normal operation of the transmission channel during a normal operation period.

When the enable signal RX_EN indicates disabling (i.e., the transmission channel from the connecting pad 110 to the core circuit 150 is disabled), the discharge switch DSW2 is turned on. For example, when the enable signal RX_EN is at a low logic level, the discharge switch DSW2 is turned on. In addition, after the integrated circuit 100 is powered off, the enable signal RX_EN is 0 volt (equivalent to “the enable signal RX_EN indicates disabling”), and the discharge switch DSW2 is turned on. Since the discharge switch DSW2 is turned on, when a higher voltage and faster EOS event occurs on the connecting pad 110, such as an IEC-61000-4-2 model level ESD power occurs, the receiving end high-impedance ESD circuit 141 may opportunely and effectively guide the EOS power to the reference voltage line VSSA. Therefore, when the EOS power of the connecting pad 110 passes through the high-pass filter 130, the ESD enhanced-protection circuit 140 may effectively prevent the EOS power that has passed through the high-pass filter 130 from damaging the core circuit 150.

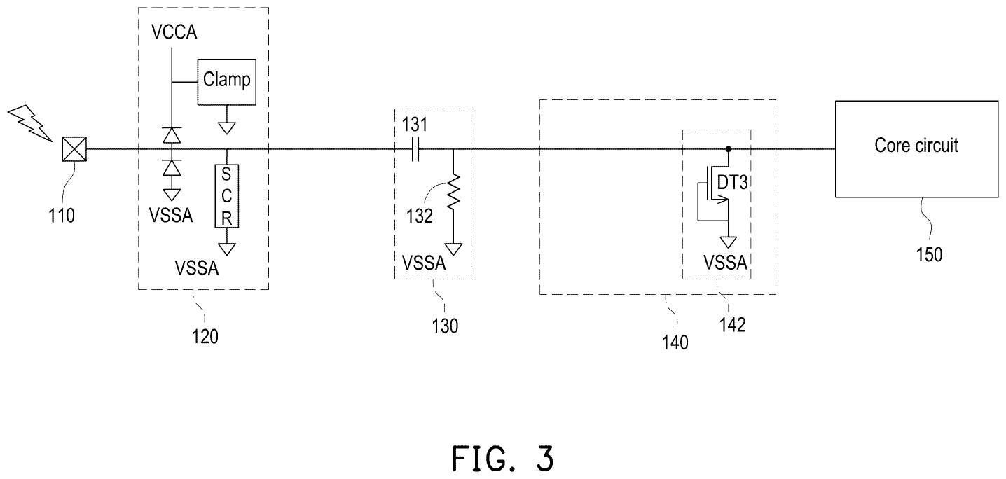

FIG. 3 is a schematic circuit diagram of the ESD enhanced-protection circuit 140 according to another embodiment of the invention. For the ESD enhanced-protection circuit 140 shown in FIG. 3, reference may be made to the relevant description of the ESD enhanced-protection circuit 140 shown in FIG. 1. The ESD enhanced-protection circuit 140 shown in FIG. 3 may be used as one of many implementations of the ESD enhanced-protection circuit 140 shown in FIG. 1. For the ESD protection circuit 120 and the high-pass filter 130 shown in FIG. 3, reference may be made to the related description of the ESD protection circuit 120 and the high-pass filter 130 shown in FIG. 2, and details thereof are not repeated here.

In the embodiment shown in FIG. 3, the ESD enhanced-protection circuit 140 includes a receiving end high-impedance ESD circuit 142. The receiving end high-impedance ESD circuit 142 includes a transistor DT3. According to an actual design, the transistor DT3 may be an N-type metal-oxide-semiconductor (NMOS) transistor or other transistors. For example, the transistor DT3 may be a grounded-gate NMOS (ggNMOS), a gate-coupling NMOS (GCNMOS) or other transistors.

A first terminal (for example, a drain) of the transistor DT3 is coupled to the second terminal of the high-pass filter 130 and the signal terminal of the core circuit 150. A second terminal (such as a source) and a control terminal (such as a gate) of the transistor DT3 are coupled to the reference voltage line VSSA. When an EOS event occurs on the connecting pad 110, the transistor DT3 is turned on to opportunely and effectively guide the EOS power to the reference voltage line VSSA. Therefore, when the EOS power of the connecting pad 110 passes through the high-pass filter 130, the ESD enhanced-protection circuit 140 may effectively prevent the EOS power that has passed through the high-pass filter 130 from damaging the core circuit 150. During the normal operation period, the transistor DT3 is turned off, so that the ESD enhanced-protection circuit 140 will not affect the normal operation of the transmission channel.

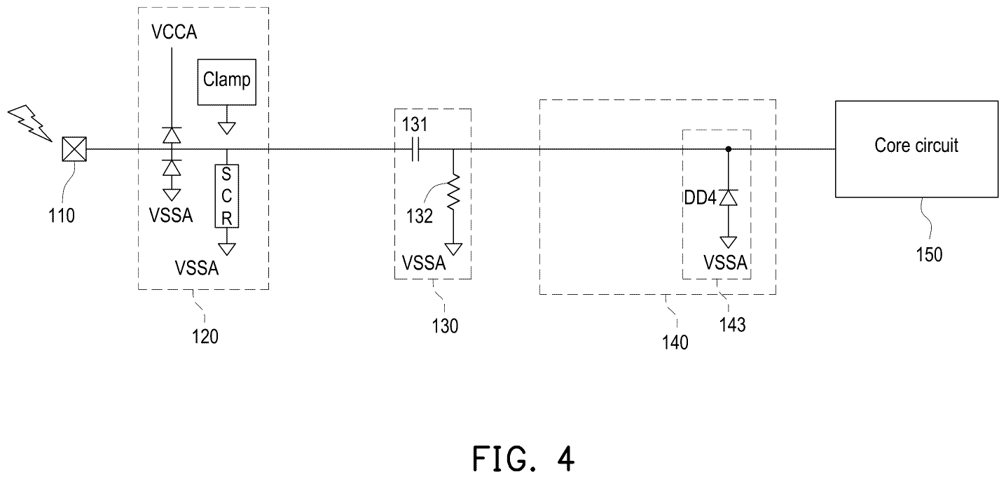

FIG. 4 is a schematic circuit diagram of an ESD enhanced-protection circuit 140 according to still another embodiment of the invention. For the ESD enhanced-protection circuit 140 shown in FIG. 4, reference may be made to the relevant description of the ESD enhanced-protection circuit 140 shown in FIG. 1. The ESD enhanced-protection circuit 140 shown in FIG. 4 may be used as one of many implementations of the ESD enhanced-protection circuit 140 shown in FIG. 1. For the ESD protection circuit 120 and the high-pass filter 130 shown in FIG. 4, reference may be made to the related descriptions of the ESD protection circuit 120 and the high-pass filter 130 shown in FIG. 2, and details thereof are not repeated here. In the embodiment of FIG. 4, the ESD enhanced-protection circuit 140 includes a receiving end high-impedance ESD circuit 143. The receiving end high-impedance ESD circuit 143 includes a diode DD4. A cathode of the diode DD4 is coupled to the second terminal of the high-pass filter 130 and the signal terminal of the core circuit 150. An anode of diode DD4 is coupled to the reference voltage line VSSA.

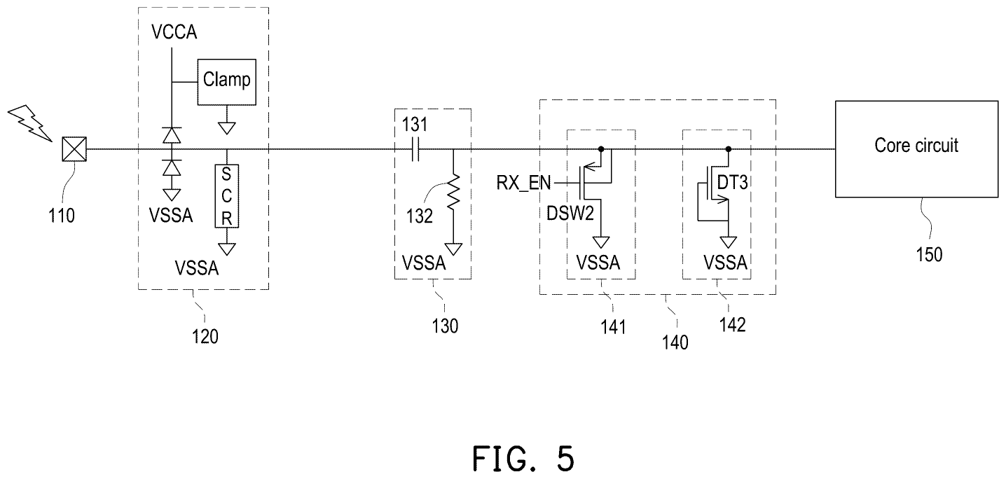

FIG. 5 is a schematic circuit diagram of an ESD enhanced-protection circuit 140 according to still another embodiment of the invention. For the ESD enhanced-protection circuit 140 shown in FIG. 5, reference may be made to the relevant description of the ESD enhanced-protection circuit 140 shown in FIG. 1. The ESD enhanced-protection circuit 140 shown in FIG. 5 may be used as one of many implementations of the ESD enhanced-protection circuit 140 shown in FIG. 1. For the ESD protection circuit 120 and the high-pass filter 130 shown in FIG. 5, reference may be made to the related descriptions of the ESD protection circuit 120 and the high-pass filter 130 shown in FIG. 2, and details thereof are not repeated here.

In the embodiment shown in FIG. 5, the ESD enhanced-protection circuit 140 includes a receiving end high-impedance ESD circuit 141 and a receiving end high-impedance ESD circuit 142. The receiving end high-impedance ESD circuit 141 includes a discharge switch DSW2. The receiving end high-impedance ESD circuit 142 includes a transistor DT3. For the receiving end high-impedance ESD circuit 141 shown in FIG. 5, reference may be made to the relevant description of the receiving end high-impedance ESD circuit 141 shown in FIG. 2, and for the receiving end high-impedance ESD circuit 142 shown in FIG. 5, reference may be made to the receiving end high-impedance ESD circuit 142 shown in FIG. 3, and details thereof are not repeated here.

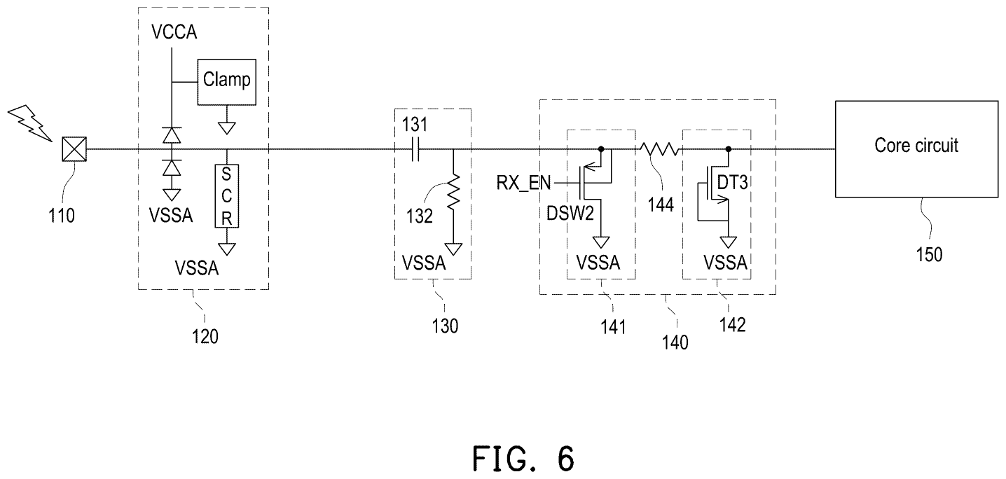

FIG. 6 is a schematic circuit diagram of an ESD enhanced-protection circuit 140 according to still another embodiment of the invention. For the ESD enhanced-protection circuit 140 shown in FIG. 6, reference may be made to the relevant description of the ESD enhanced-protection circuit 140 shown in FIG. 1. The ESD enhanced-protection circuit 140 shown in FIG. 6 may be used as one of many implementations of the ESD enhanced-protection circuit 140 shown in FIG. 1. For the ESD protection circuit 120 and the high-pass filter 130 shown in FIG. 6, reference may be made to the related descriptions of the ESD protection circuit 120 and the high-pass filter 130 shown in FIG. 2, and details thereof are not repeated here.

In the embodiment shown in FIG. 6, the ESD enhanced-protection circuit 140 includes a receiving end high-impedance ESD circuit 141, a receiving end high-impedance ESD circuit 142 and a resistor 144. The receiving end high-impedance ESD circuit 141 includes a discharge switch DSW2. The receiving end high-impedance ESD circuit 142 includes a transistor DT3. A first terminal of the resistor 144 is coupled to the first terminal of the ESD enhanced-protection circuit 140, i.e., coupled to the second terminal of the high-pass filter 130. A second terminal of the resistor 144 is coupled to the second terminal of the ESD enhanced-protection circuit 140, i.e., coupled to the signal terminal of the core circuit 150. A resistance of the resistor 144 may be determined according to an actual design.

A first terminal of the discharge switch DSW2 is coupled to the first terminal of the ESD enhanced-protection circuit 140. A second terminal of the discharge switch DSW2 is coupled to the reference voltage line VSSA. A control terminal of the discharge switch DSW2 is controlled by the enable signal RX_EN of the core circuit 150. When the enable signal RX_EN indicates disabling, the discharge switch DSW2 is turned on. When the enable signal RX_EN indicates enabling, the discharge switch DSW2 is turned off. A first terminal of the transistor DT3 is coupled to the second terminal of the ESD enhanced-protection circuit 140. A second terminal and a control terminal of the transistor DT3 are coupled to the reference voltage line VSSA. For the receiving end high-impedance ESD circuit 141 and the discharge switch DSW2 shown in FIG. 6, reference may be made to the relevant descriptions of the receiving end high-impedance ESD circuit 141 and the discharge switch DSW2 shown in FIG. 2, and for the receiving end high-impedance ESD circuit 142 and the transistor DT3 shown in FIG. 6, reference may be made to the relevant descriptions of the receiving end high-impedance ESD circuit 142 and the transistor DT3 shown in FIG. 3, and details thereof are not repeated here.

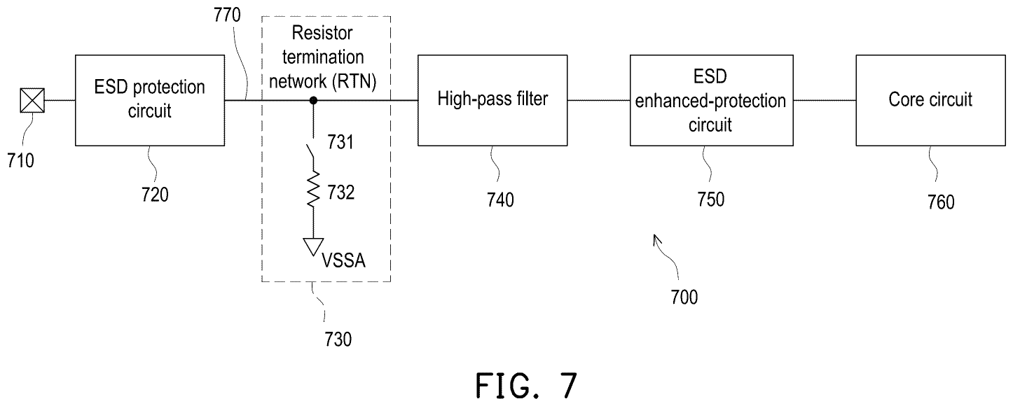

FIG. 7 is a schematic circuit block diagram of an integrated circuit 700 according to another embodiment of the invention. The integrated circuit 700 shown in FIG. 7 includes a connecting pad 710, an ESD protection circuit 720, a resistor termination network (RTN) 730, a high-pass filter 740, an ESD enhanced-protection circuit 750, and a core circuit 760. For the integrated circuit 700, the connecting pad 710, the ESD protection circuit 720, the high-pass filter 740, the ESD enhanced-protection circuit 750 and the core circuit 760 shown in FIG. 7, reference may be made to relevant descriptions of the integrated circuit 100, the connecting pad 110, the ESD protection circuit 120, the high-pass filter 130, the ESD enhanced-protection circuit 140 and the core circuit 150 shown in FIG. 1, and details thereof are not repeated here.

The resistor termination network 730 is coupled to a conductor line 770, where the conductor line 770 connects the connecting pad 710 and the first terminal of the high-pass filter 740. In the embodiment shown in FIG. 7, the resistor termination network 730 includes a switch 731 and a resistor 732. The switch 731 and the resistor 732 are connected in series between the conductor line 770 and the reference voltage line VSSA. A resistance of the resistor 732 may be determined according to an actual design. For example, in some embodiments, the resistance of the resistor 732 may be within a range from 10Ω to 100Ω. It should be noted that the specific implementation of the resistor termination network 730 should not be limited to the circuit diagram shown in FIG. 7. According to the actual design, the resistor termination network 730 may have other impedance matching circuits.

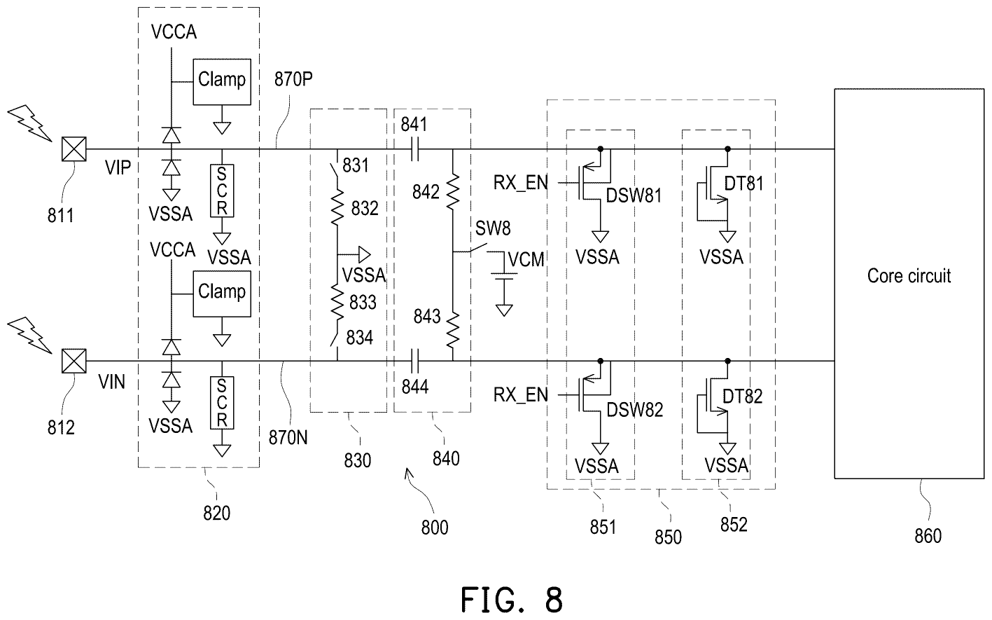

The integrated circuit 100 shown in FIG. 1 and the integrated circuit 700 shown in FIG. 7 may be implemented as single-ended signal circuits or as differential signal circuits. A user of the invention may analogize any one of the embodiments in FIG. 1 to FIG. 7 as a differential signal circuit. For example, FIG. 8 is a schematic circuit block diagram of an integrated circuit 800 according to another embodiment of the invention. The integrated circuit 800 shown in FIG. 8 includes a connecting pad 811, a connecting pad 812, an ESD protection circuit 820, a resistor termination network 830, a high-pass filter 840, an ESD enhanced-protection circuit 850 and a core circuit 860. The connecting pad 811 and the connecting pad 812 are respectively used to transmit differential signals VIP and VIN. For the integrated circuit 800, connecting pads 811, 812, the ESD protection circuit 820, the resistor termination network 830, high-pass filter 840, the ESD enhanced-protection circuit 850 and the core circuit 860 shown in FIG. 8, reference and deduction may be made to relevant descriptions of the integrated circuit 700, the connecting pad 710, the ESD protection circuit 720, the resistor termination network 730, the high pass filter 740, the ESD enhanced-protection circuit 750, and the core circuit 760 of FIG. 7. For the ESD protection circuit 820 shown in FIG. 8, reference may be made to the relevant description of the ESD protection circuit 120 shown in FIG. 2, and details thereof are not repeated.

In the embodiment shown in FIG. 8, the resistor termination network 830 includes a switch 831, a resistor 832, a resistor 833 and a switch 834. The switch 831 and the resistor 832 are connected in series between a conductor line 870P and the reference voltage line VSSA. The switch 834 and the resistor 833 are connected in series between a conductor line 870N and the reference voltage line VSSA. Resistances of the resistor 832 and the resistor 833 may be determined according to an actual design. For example, in some embodiments, the resistances of the resistor 832 and/or the resistor 833 may be within a range of 10Ω to 100Ω. For the switch 831 and the switch 834 shown in FIG. 8, reference may be made to the relevant description of the switch 731 shown in FIG. 7, and for the resistor 832 and the resistor 833 shown in FIG. 8, reference may be made to the relevant description of the resistor 732 shown in FIG. 7, so that details thereof are not repeated. It should be noted that the specific implementation of the resistor termination network 830 should not be limited to the circuit diagram shown in FIG. 8. According to an actual design, the resistor termination network 830 may have other impedance matching circuits.

In the embodiment shown in FIG. 8, the high-pass filter 840 includes a capacitor 841, a resistor 842, a resistor 843 and a capacitor 844. A first terminal of the capacitor 841 is coupled to the connecting pad 811. A second terminal of the capacitor 841 is coupled to the ESD enhanced-protection circuit 850. A first terminal of the capacitor 844 is coupled to connecting pad 812. A second terminal of the capacitor 844 is coupled to the ESD enhanced-protection circuit 850. Capacitances of the capacitor 841 and the capacitor 844 may be determined according to an actual design. For example, in some embodiments, the capacitances of the capacitor 841 and/or the capacitor 844 may be within a range of 1 pF to 10 pF. A first terminal of the resistor 842 is coupled to the second terminal of the capacitor 841. A second terminal of the resistor 842 is coupled to a common mode voltage line VCM through a switch SW8. A first terminal of the resistor 843 is coupled to the second terminal of the capacitor 844. A second terminal of the resistor 843 is coupled to the common mode voltage line VCM through the switch SW8. Resistances of the resistor 842 and the resistor 843 may be determined according to an actual design. For example, in some embodiments, the resistances of the resistor 842 and/or the resistor 843 may be within a range from 100 KΩ to 500 KΩ. The switch SW8 may be controlled by the enable signal RX_EN of the core circuit 150. For the capacitor 841 and the capacitor 844 shown in FIG. 8, reference may be made to the relevant description of the capacitor 131 of FIG. 2, and for the resistor 842 and the resistor 843 shown in FIG. 8, reference may be made to the relevant description of the resistor 132 shown in FIG. 2, so that details thereof are not repeated. It should be noted that the specific implementation of the high-pass filter 840 should not be limited to the circuit diagram shown in FIG. 8. According to the actual design, the high-pass filter 840 may have other filter circuits.

In the embodiment shown in FIG. 8, the ESD enhanced-protection circuit 850 includes a receiving end high-impedance ESD circuit 851 and a receiving end high-impedance ESD circuit 852. The receiving end high-impedance ESD circuit 851 includes a discharge switch DSW81 and a discharge switch DSW82. The receiving end high-impedance ESD circuit 852 includes a transistor DT81 and a transistor DT82. For the receiving end high-impedance ESD circuit 851, the discharge switch DSW81 and the discharge switch DSW82 shown in FIG. 8, reference may be made to the relevant descriptions of the receiving end high-impedance ESD circuit 141 and the discharge switch DSW2 shown in FIG. 2, and for the receiving end high-impedance ESD circuit 852, the transistor DT81 and the transistor DT82 shown in FIG. 8, reference may be made to the relevant descriptions of the receiving end high-impedance ESD circuit 142 and the transistor DT3 shown in FIG. 3, so that details thereof are not repeated here.

It should be noted that the specific implementation of the ESD enhanced-protection circuit 850 should not be limited to the circuit diagram shown in FIG. 8. According to the actual design, the ESD enhanced-protection circuit 850 may have other ESD circuits. For example, in different embodiments, for the ESD enhanced-protection circuit 850 shown in FIG. 8, reference may be made to the relevant description of the ESD enhanced-protection circuit 140 shown in FIG. 2, FIG. 3, FIG. 4, FIG. 5 or FIG. 6.

In summary, the ESD protection circuit 820 described in the embodiment of the invention may provide the ESD protection function. For example, in some application scenarios, the ESD protection circuit 820 may effectively prevent human-body model (HBM) or machine model (MM) level ESD power from damaging the core circuit 860. When a higher voltage and faster EOS event occurs on the connecting pad 811 and/or the connecting pad 812, such as an IEC-61000-4-2 model level ESD power occurs, the ESD protection circuit 860 may not have time to direct all of EOS power to the reference voltage line VSSA, so that the EOS power may probably pass through the high-pass filter 840. At this time, the ESD enhanced-protection circuit 850 may effectively may opportunely guide the EOS power to the reference voltage line VSSA, thereby effectively preventing the EOS power that has passed through the high-pass filter from damaging the core circuit 860.

It will be apparent to those skilled in the art that various modifications and variations can be made to the disclosed embodiments without departing from the scope or spirit of the invention. In view of the foregoing, it is intended that the invention covers modifications and variations provided they fall within the scope of the following claims and their equivalents.

What is claimed is:

1. An integrated circuit, comprising:
a core circuit;
a connecting pad;
a high-pass filter wherein a first terminal of the high-pass filter is coupled to the connecting pad;
an electrostatic discharge protection circuit coupled to the connecting pad and the first terminal of the high-pass filter; and
an electrostatic discharge enhanced-protection circuit, wherein a first terminal of the electrostatic discharge enhanced-protection circuit is coupled to a second terminal of the high-pass filter, and a second terminal of the electrostatic discharge enhanced-protection circuit is coupled to a signal terminal of the core circuit.

2. The integrated circuit according to claim 1, wherein the core circuit comprises an equalizer, a loss of signal detection circuit or an amplifier.

3. The integrated circuit according to claim 1, wherein the high-pass filter comprises:
a capacitor, wherein a first terminal of the capacitor is coupled to the first terminal of the high-pass filter, and a second terminal of the capacitor is coupled to the second terminal of the high-pass filter; and
a resistor, wherein a first terminal of the resistor is coupled to the second terminal of the capacitor, and a second terminal of the resistor is coupled to a reference voltage line.

4. The integrated circuit according to claim 1, wherein the electrostatic discharge enhanced-protection circuit comprises:
a discharge switch, wherein a first terminal of the discharge switch is coupled to the second terminal of the high-pass filter and the signal terminal of the core circuit, a second terminal of the discharge switch is coupled to a reference voltage line, and a control terminal of the discharge switch is controlled by an enable signal of the core circuit,
wherein when the enable signal indicates disabling, the discharge switch is turned on, and
when the enable signal indicates enabling, the discharge switch is turned off.

5. The integrated circuit according to claim 1, wherein the electrostatic discharge enhanced-protection circuit comprises:
a transistor, wherein a first terminal of the transistor is coupled to the second terminal of the high-pass filter and the signal terminal of the core circuit, and a second terminal and a control terminal of the transistor are coupled to a reference voltage line.

6. The integrated circuit according to claim 1, wherein the electrostatic discharge enhanced-protection circuit comprises:
a diode, wherein a cathode of the diode is coupled to the second terminal of the high-pass filter and the signal terminal of the core circuit, and an anode of the diode is coupled to a reference voltage line.

7. The integrated circuit according to claim 1, wherein the electrostatic discharge enhanced-protection circuit comprises:
a discharge switch, wherein a first terminal of the discharge switch is coupled to the second terminal of the high-pass filter and the signal terminal of the core circuit, a second terminal of the discharge switch is coupled to a reference voltage line, a control terminal of the discharge switch is controlled by an enable signal of the core circuit, when the enable signal indicates disabling, the discharge switch is turned on, and when the enable signal indicates enabling, the discharge switch is turned off; and
a diode, wherein a cathode of the diode is coupled to the second terminal of the high-pass filter and the signal terminal of the core circuit, and an anode of the diode is coupled to the reference voltage line.

8. The integrated circuit according to claim 1, wherein the electrostatic discharge enhanced-protection circuit comprises:
a resistor, wherein a first terminal of the resistor is coupled to the first terminal of the electrostatic discharge enhanced-protection circuit, and a second terminal of the resistor is coupled to the second terminal of the electrostatic discharge enhanced-protection circuit;
a discharge switch, wherein a first terminal of the discharge switch is coupled to the first terminal of the electrostatic discharge enhanced-protection circuit, a second terminal of the discharge switch is coupled to a reference voltage line, a control terminal of the discharge switch is controlled by an enable signal of the core circuit, when the enable signal indicates disabling, the discharge switch is turned on, and when the enable signal indicates enabling, the discharge switch is turned off; and
a transistor, wherein a first terminal of the transistor is coupled to the second terminal of the electrostatic discharge enhanced-protection circuit, and a second terminal and a control terminal of the transistor are coupled to the reference voltage line.

9. The integrated circuit according to claim 1, further comprising:
a resistor termination network coupled to a conductor line connected to the connecting pad and the first terminal of the high-pass filter.

10. The integrated circuit according to claim 9, wherein the resistor termination network comprises:
a switch; and
a resistor, wherein the switch and the resistor are connected in series between the conductor line and a reference voltage line.
